(19) United States
(12) Patent Application Publication
(10) Pub. No.: US 2014/0193671 A1
(43) Pub. Date: Jul. 10, 2014

(54) Portable Fuel Cell System Having a Fuel Cell System Controller

(71) Applicant: LILLIPUTIAN SYSTEMS, INC., Wilmington, MA (US)

(72) Inventors: John A. Rule, Carlisle, MA (US); Jacob P. Lipcon, Arlington, MA (US); Armin B. Kusig, Wayland, MA (US); John P. Fallon, Danvers, MA (US)

(73) Assignee: LILLIPUTIAN SYSTEMS, INC., Wilmington, MA (US)

(21) Appl. No.: 13/734,911

(22) Filed: Jan. 4, 2013

(51) Int. Cl. H01M 8/04

(52) U.S. Cl. CPC H01M 8/04932
USPC 429/9; 429/430; 429/429

(57) ABSTRACT

A portable fuel cell system includes a fuel cell having a plurality of flow inputs and a power output, a temperature sensor configured to measure operating temperature of the fuel cell, a power output sensor coupled to the fuel cell and configured to measure a power parameter related to fuel cell power output, a controllable power converter, coupled to the power output of the fuel cell, that transfers power from the fuel cell to the fuel cell system, and a flow control device coupled to a first flow input and configured to control a first one of the flow inputs into the fuel cell. The system further includes a fuel cell system controller, coupled to the fuel cell, the power output, the temperature sensor, the power output sensor, the controllable power converter, and the flow control device.

### CROSS REFERENCE TO RELATED APPLICATIONS

The present application is related to U.S. patent application entitled FUEL CELL SYSTEMS AND RELATED METHODS, Attorney Docket No. 3553/138, filed on Jan. 4, 2013, U.S. patent application entitled A FUEL CELL SYSTEM HAVING AN AIR QUALITY SENSOR SUITE, Attorney Docket No. 3553/139, filed on Jan. 4, 2013, U.S. patent application entitled FUEL CELL SYSTEM HAVING A PUMP AND RELATED METHOD, Attorney Docket No. 3553/141, filed on Jan. 4, 2013, U.S. patent application entitled A FUEL CELL SYSTEM HAVING WATER VAPOR CONDENSATION PROTECTION, Attorney Docket No. 3553/142, filed on Jan. 4, 2013, U.S. patent application entitled A FUEL CELL SYSTEM HAVING A SAFETY MODE, Attorney Docket No. 3553/143, filed on Jan. 4, 2013, U.S. patent application entitled A METHOD FOR BONDING SUBSTRATES, Attorney Docket No. 3553/145, filed on Jan. 4, 2013, and U.S. patent application entitled LOW VIBRATION LINEAR MOTOR SYSTEMS, Attorney Docket No. 3553/146, filed on Jan. 4, 2013, the disclosures of which are incorporated by reference herein in their entirety.

### TECHNICAL FIELD

The present invention relates to a portable fuel cell system, and more particularly to a portable fuel cell system having a fuel cell system controller for implementing temperature, power, and power control loops.

### BACKGROUND ART

The operation of a fuel cell is known in prior art; however, most of the methods of operation involve larger fuel cell systems. These large, non-portable systems have fundamentally different operational goals and operating parameters than a personal portable fuel cell system. This is especially true for the class of fuel cells known as solid oxide fuel cells (SOFC).

Improvements in energy density and chemical conversion efficiency have been achieved with the above-mentioned solid-oxide-fuel cells (SOFCs), which utilize ceramic membranes instead of polymer membranes. In the SOFC systems, an oxidizing flow is passed through the cathode side of the fuel cell while a reducing flow is passed through the anode side of the fuel cell. The oxidizing flow is typically air, while the reducing flow typically comprises a mixture of a hydrogen-rich gas created by reforming a hydrocarbon fuel source and an oxygen source such as air, water vapor or carbon dioxide. The fuel cell, typically operating at a temperature between 500° C. and 1000° C., enables the transport of negatively charged oxygen ions from the cathode flow stream to the anode flow stream, where the ions combine with either free hydrogen or hydrogen in a hydrocarbon molecule to form water vapor and/or with carbon monoxide to form carbon dioxide. The excess electrons from the negatively charged ions are routed back to the cathode side of the fuel cell through an electrical circuit completed between the anode and the cathode, resulting in an electrical current flow through the circuit.

Because the SOFC systems generally are required to operate between 500-1000° C. to enable the electrochemical reactions, in a large system it can take the fuel cell a significant time to achieve operating temperature. Once a fuel cell has achieved operating temperature, it typically maintains this temperature by tuning the system inputs. Additionally, the system temperature can be controlled by an active heat exchanger. This heat exchanger either adds or removes thermal energy from the fuel cell system, keeping a substantially constant temperature in the running system.

In a small system, it is very complicated and expensive to support a separate heat exchanger for temperature regulation. The power required to run this heat exchanger would drastically reduce the system's overall efficiency. Instead, this system is designed to have a substantially constant heat loss at given operating temperature. This design constraint affects the method for optimal operation of the system.

There exist prior fuel cell systems where the power output from the system is designed to be constant throughout the system's lifetime. These systems' power output limits are often dependent on the load the fuel cell system is attached to. The demonstrated prior art method of controlling power output is to control the fuel cell stack output to a constant voltage or at a constant current.

In a constant voltage system, power is extracted from the fuel cell by holding the fuel cell electrical potential at a fixed voltage. The amount of power produced is altered by changing the fuel and air inputs to the system.

In a current system, power is extracted from the fuel cell by measuring the output current from the fuel cell. The amount of current produced is altered by changing the fuel and air inputs to the system.

These limitations and others result in prior art systems which are less efficient, have lower power output, and have higher decay.

### SUMMARY OF THE EMBODIMENTS

In one embodiment of the invention, a portable fuel cell system includes a fuel cell having a plurality of flow inputs and a power output, a temperature sensor configured to measure operating temperature of the fuel cell, a power output sensor coupled to the fuel cell and configured to measure a power parameter related to fuel cell power output, a controllable power converter, coupled to the power output of the fuel cell, that transfers power from the fuel cell to the fuel cell system, and a flow control device coupled to a first flow input and configured to control a first one of the flow inputs into the fuel cell. The system further includes a fuel cell system controller, coupled to the fuel cell, the power output, the temperature sensor, the power output sensor, the controllable power converter, and the flow control device. The fuel cell system controller is configured to operate a power control loop, having the measured power parameter as an input, configured to set a temperature target value of the fuel cell temperature to cause the measured power parameter to match a power target value, a fuel cell temperature control loop, having the measured operating temperature of the fuel cell as an input, configured to adjust the first flow using the first flow control device to cause the measured operating temperature of the fuel cell to match the temperature target value, and a power converter control loop, having the measured power parameter as an input, configured to adjust the controllable power converter to maximize the measured power parameter.

In related embodiments, the fuel cell system controller may be further configured to operate a power target control loop, having at least one parameter associated with operation of the fuel cell system as an input, configured to set the power target value. The at least one parameter may include at least one member selected from the group consisting of amount of power being used to charge a battery that is coupled to the power output, amount of power from the system being delivered to an external load, amount of power required to run the system, amount of the fuel cell power output, and combinations thereof. The power target value may be a difference between the amount of the fuel cell power output and the amount of the power required to run the system. The power target value may be the sum of the amount of power being used to charge the battery, the amount of power being delivered to the external load, and the amount of power required to run the system. The power target value may be a fixed number based on a performance level of the fuel cell system. The fuel cell system controller may be further configured to operate the power converter control loop whenever the fuel cell is producing power. The fuel cell power target control loop may be further configured to set the power target value to be within a power target window. The fuel cell power control loop may be further configured to set the temperature target value to be within a temperature target window. The fuel cell temperature control loop may be further configured to set the flow control value to be within a flow control window. The controllable power converter may be configured to operate within a power window of values of the power output of the fuel cell.

In further related embodiments, the fuel cell system controller may be configured to run in each of at least three operating states, but in only one of the operating states at a given time. The states may include startup operation of the fuel cell to prepare the system to produce power, operation of the fuel cell in which the fuel cell produces power, and shutdown of the fuel cell to cause the system to stop the production of power. The fuel system controller may be configured to change an initial target value for at least one of the control loops in the system depending on the current operating state of the fuel cell system controller. The fuel system controller may be configured to modify the window applicable to at least one of the control loops in the system depending on the current operating state of the fuel cell system controller. The fuel cell system controller may be configured to store a past target value used in at least one of the control loops. The fuel cell system controller may be configured to set the target value for at least one of the control loops based upon one or more past target values. The portable fuel cell system may further include an electrical fuel cell heater and an electrical heater controller. The fuel cell may be a solid oxide fuel cell. The fuel cell may use a liquid hydrocarbon fuel. For example, the fuel may be butane.

### BRIEF DESCRIPTION OF THE DRAWINGS

The foregoing features of embodiments will be more readily understood by referencing the following detailed description, taken with reference to the accompanying drawings, in which:

FIG. 1 is a schematic diagram illustrating a portable fuel cell system in accordance with one embodiment of the present invention.

FIGS. 2A-2D are schematic diagrams illustrating an overall implementation of control loops by a fuel system controller in accordance with one embodiment of the present invention. FIG. 2A shows a power control loop (outlined in bold for ease of representation); FIG. 2B shows a temperature control loop outlined in bold; FIG. 2C shows a temperature control loop of FIG. 2B, wherein a fuel cell additionally includes an electrical heater; and FIG. 2D depicts a power converter control loop outlined in bold lines.

FIG. 3 is a schematic diagram illustrating an overall implementation of control loops by a fuel system controller in accordance with another related embodiment of the present invention; the figure details a power target control loop outlined in bold lines.

FIG. 4 is a graph showing the change in the fuel cell power with respect to operating voltage at two different operating conditions of the fuel cell system in accordance with one embodiment of the present invention.

FIG. 5 is a table illustrating a potential system response to the initial change in the operating environment in accordance with one embodiment of the present invention.

### DETAILED DESCRIPTION OF SPECIFIC EMBODIMENTS

### Definitions

As used in this description and the accompanying claims, the following terms shall have the meanings indicated, unless the context otherwise requires:

A “fuel cell” is any portion of the system containing at least part of the electrochemical conversion structures, including an anode, electrolyte and cathode, and also including portions of the housings, flow conduits, electronics, and other associated peripheral components coupled to the electrochemical structures.

Controlling a “flow input” in a control loop herein means controlling fuel flow, or oxidizer flow, or flow of fuel mixed with air in the control loop. A fuel cell system in accordance with embodiments herein has other control mechanisms not described herein that, for example, correspondingly control air flow when fuel flow is controlled and that correspondingly control fuel flow when air flow is controlled; specifically, fuel flow and air flow are controlled so as to be generally ratiometric.

An “operation cycle” is the process of starting up the fuel cell, producing power, and shutting down the fuel cell.

A “control loop” is implemented as a configuration of a fuel cell system controller wherein the controller uses one or more input signals to determine one or more output signals, and wherein one or more output signals produce an effect on at least one of the input signals.

A “flow control device” is a stand-alone device, or a group of discrete devices, configured to modulate a material flow in response to a control signal.

A “fuel cell system controller” is a set of one or more hardware components, including memory and a processor, configured to run one or more software-based components that implement an application for controlling the fuel cell system. In another implementation, the fuel system controller includes discrete electrical or mechanical components that implement control features required by the fuel cell system.

The system “total power” is instantaneous electrical power generated by the fuel cell.

The “balance of plant power” is the sum of the power used by the fuel cell system that is required to keep the fuel cell system running. This includes, but is not limited to, power required to run the microprocessor, sensors, pump, and fans.

The system “net power” is defined as the total power minus the balance of plant power.

The “load voltage” is the electrical potential of the programmable power converter.

For a small portable SOFC system, the previously disclosed modes of operation can cause serious limitations to the power produced by the system. In order to overcome those limitations and produce a higher efficiency system, embodiments of the present invention combine identified measurement parameters with specifically designed control loops and control mechanisms to optimize performance of the system.

The system operation and control design described herein enables the fuel cell system to operate in a plurality of environments with increased efficiency and without harm to the fuel cell. Furthermore, the designed interactions of the control loops in the fuel cell control system enable moving an active system, making it possible for operation to continue even when a system is quickly moved from one operating environment to another operating environment. In a specific example, a system operating inside a climate-controlled building will require different operating parameters from a system operating outside in a climate with cold dry air.

In an indoor environment with 60% humidity and an ambient temperature of 23° C., the fuel cell system will have a first set of parameters to produce 5 Ws of net power. These parameters include, but are not limited to, the fuel cell operating temperature, fuel and oxidizer flow rates, the balance of plant power, and power controller voltage. As only an illustrative example, a system moved from a warm, humid indoor environment to the outdoor dry, colder environment with 10% humidity and an ambient temperature of 5° C., will have to change to a second set of operating parameters to maintain the same 5 W net power output level. If the system does not dynamically adjust to the second set of operating parameters, the power level produced could decrease or it is possible the fuel cell could be permanently damaged. In the colder outdoor environment, more thermal energy may be required to keep the system warm. The stoichiometric balance of oxygen to carbon will be altered by the change in environmental humidity, requiring the flow rate to be adjusted. Additionally, the change in fuel concentrations on the fuel cell may alter the voltage at which the fuel cell generates peak power, requiring the power controller voltage set point to change to the new peak power setting.

No prior art solid oxide fuel cell system has required the level of dynamic flexibility enabled by the embodiments disclosed in the present invention. Most prior art systems are stationary installations or large systems designed to provide power to a vehicle. Furthermore, these large installations are generally designed to operate at a constant temperature and with a fixed load.

In the preferred embodiment of the disclosed fuel cell system, in which the system controls a solid oxide fuel cell, the power generated by the cell can be increased, or decreased, by changing the operating temperature. For fuel cells, one possible metric of performance is power density, the power produced per square meter of fuel cell area (W/m2). For solid oxide fuel cells within the devices operating ranges, the power for a given area of fuel cell can be changed by changing the operating temperature. As the operating temperature is increased, as long as excess fuel is available, the power production of the fuel cell increases. In the disclosed portable system, if the target power production of the portable system is greater than the power being produced; the system operating temperature is increased until the produced power matches the target power. Additionally, as the fuel cell system ages, the power density of the fuel cell may degrade. The control system may be designed to adapt to the changing power density of the fuel cell to achieve a desired level of performance from the system. As the power density degrades with extended operation, the system control can compensate by increasing operating temperature. Yet another application of tuning the power generated by the fuel cell system would be to meet short term requirements for above normal power output. As an example, a fuel cell system may be required to provide a short term, high current power output to rapidly charge a load device. A miniature fuel cell can quickly adjust its operating temperature to meet the short term, high power requirements. After the demand for above nominal operation has passed, the system could return to the previous operating mode.

The described flexibility of the fuel cell system, which enables the device to meet varying power demands, as well as adjust to long term changes in performance, requires the system to contain a temperature control loop. In one possible embodiment, the temperature control loop controls an electrical heater, as well as the system fuel and gas flow. The electrical heater uses joule heating to increase the temperature of the fuel cell. Assuming sufficient oxidizer, the fuel flow rate is directly related to heat generated in the fuel cell. The combustion of fuel creates heat. Increasing or decreasing the fuel flow will increase or decrease the fuel cell temperature.

In the preferred implementation, the oxidizer flow is controlled ratiometrically to the fuel flow. In another implementation, the fuel flow could be controlled as a ratio of the oxidizer flow. In yet another implementation, the fuel cell system controller adjusts one or more of the flows independently. The set flow rates would be determined by the current operating environment and the operational requirements of the fuel cell.

As described above, changes in the parameters around the fuel cell operation may change the voltage at which the maximum power can be transferred to the power converter from the fuel cell.

The controllable power converter control loop continually monitors the power generated by the fuel cell. In the preferred implementation, it is desirable to configure the power converter to continually seek a more optimal load setting.

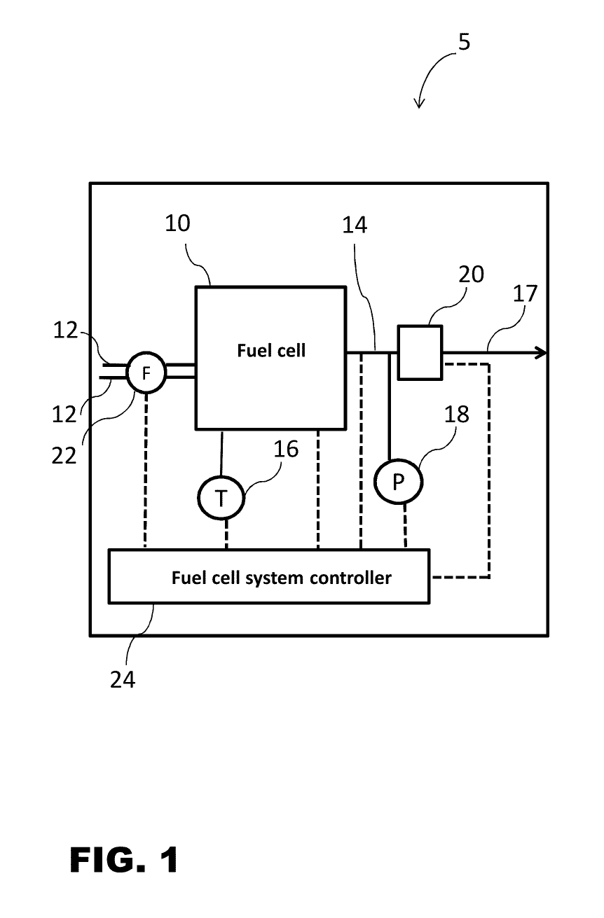

FIG. 1 illustrates a portable fuel cell system 5 according to one embodiment of the present invention. Fuel cell system 5 includes fuel cell 10 having a plurality of flow inputs 12 and power output 14, temperature sensor 16 configured to measure the operating temperature of the fuel cell 10, power output sensor 18 coupled to the fuel cell 10 and configured to measure a power parameter related to fuel cell power output 14. The fuel cell system 5 includes controllable power converter 20 to transfer power from the fuel cell 10 to the fuel cell system 5. The fuel cell system 5 includes flow control device 22 coupled to at least one of the flow inputs 12 and configured to control the flow into the fuel cell 10. The fuel cell system 5 further includes fuel cell system controller 24, coupled to the fuel cell 10, the power output 14, the temperature sensor 16, the power output sensor 18, the controllable power converter 20, and the flow control device 22.

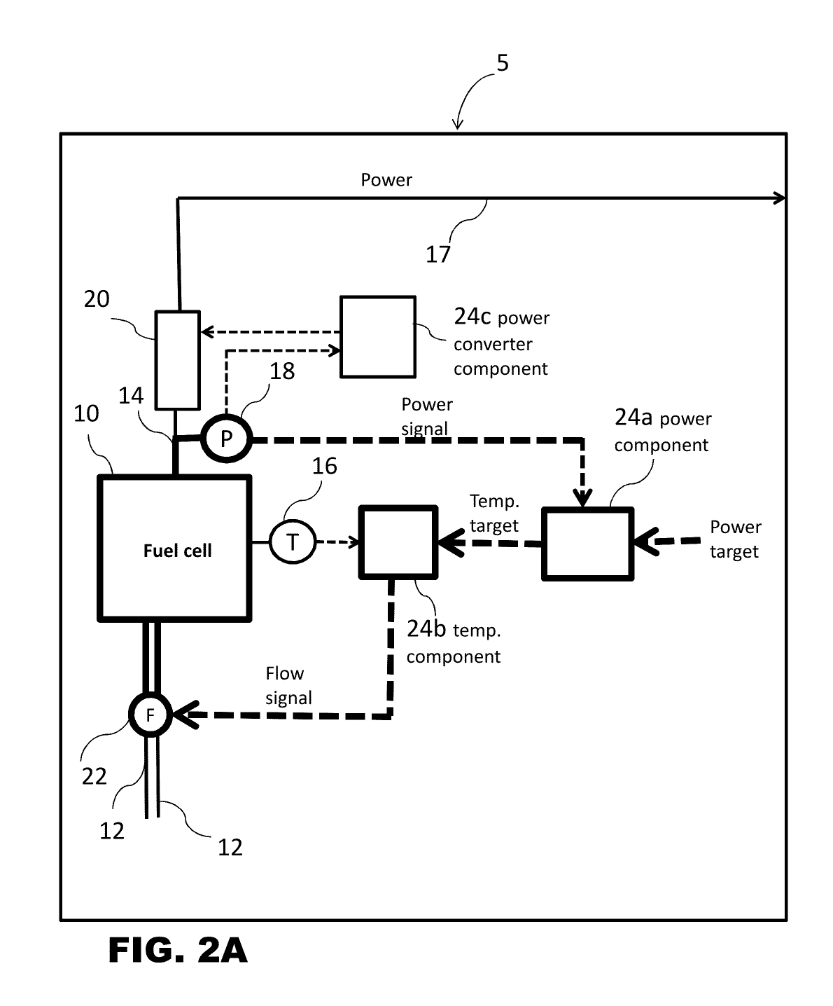

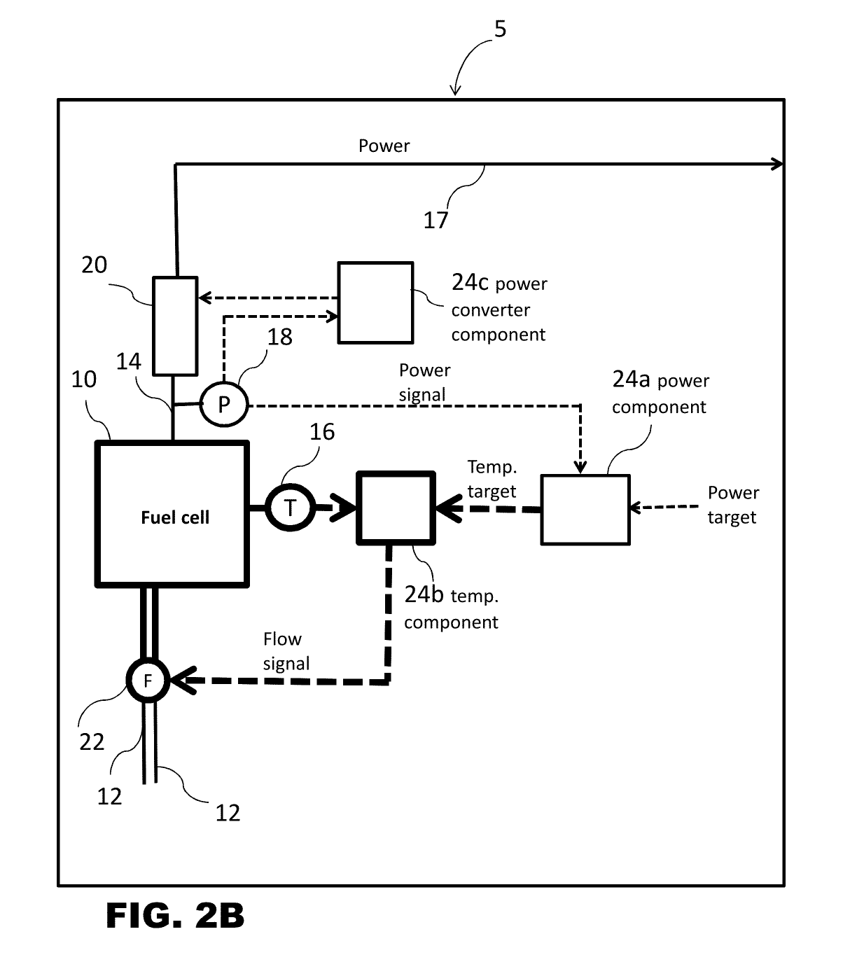

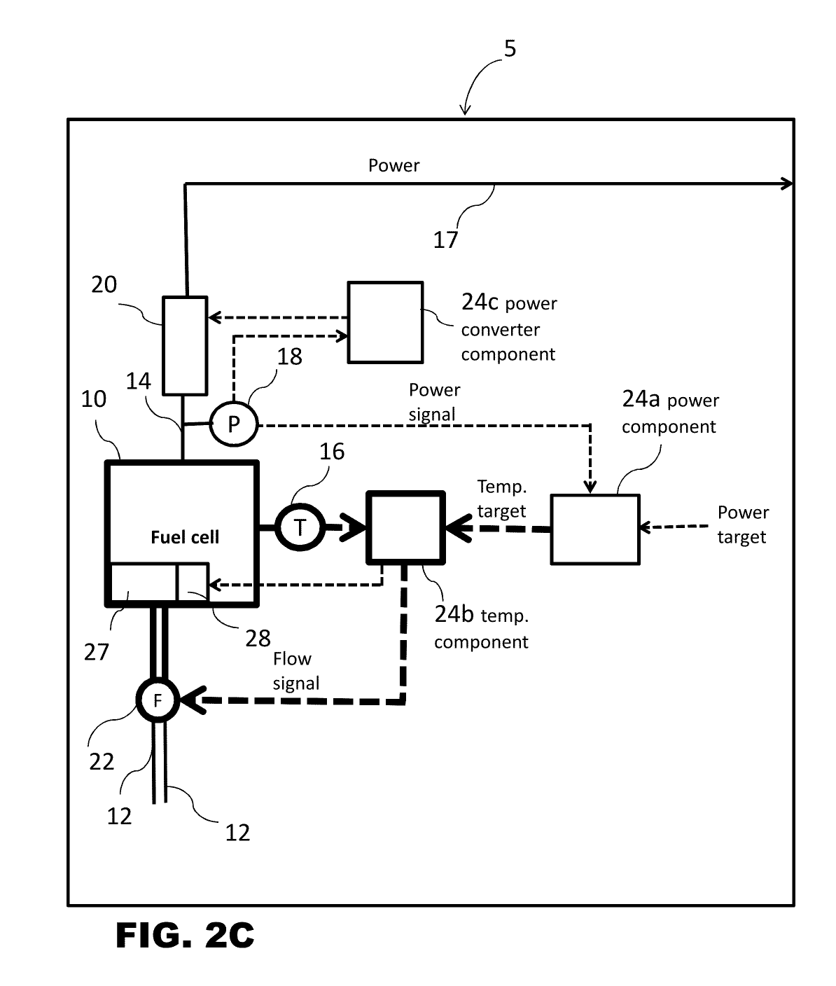

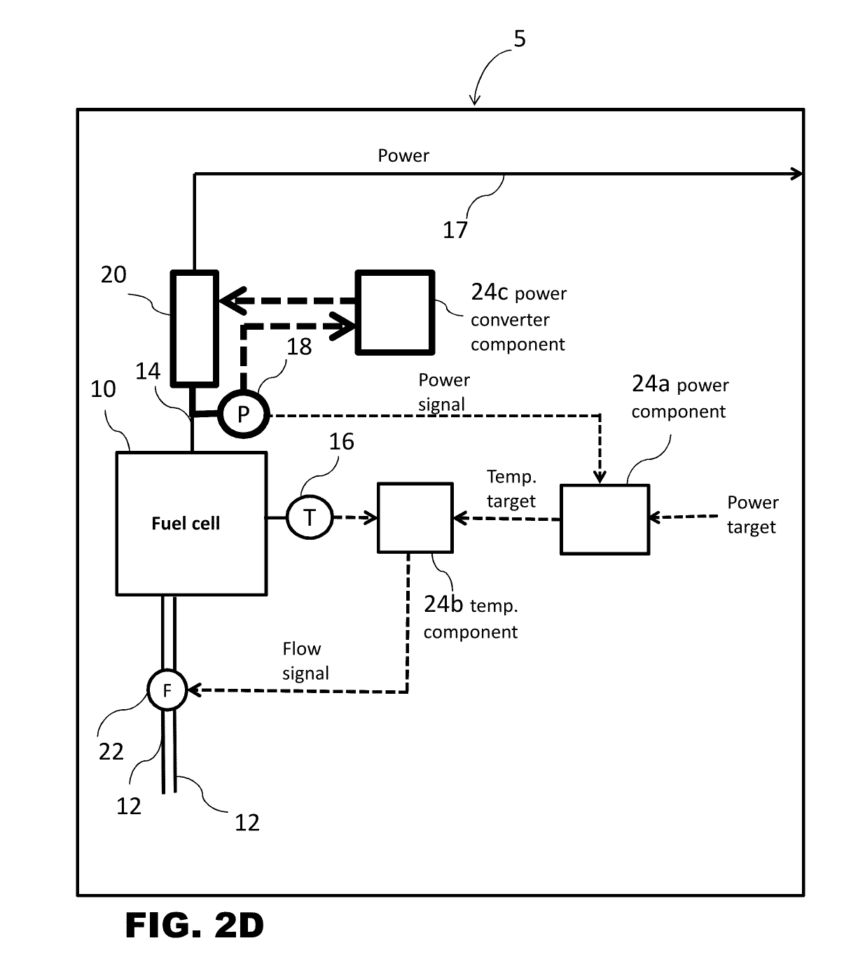

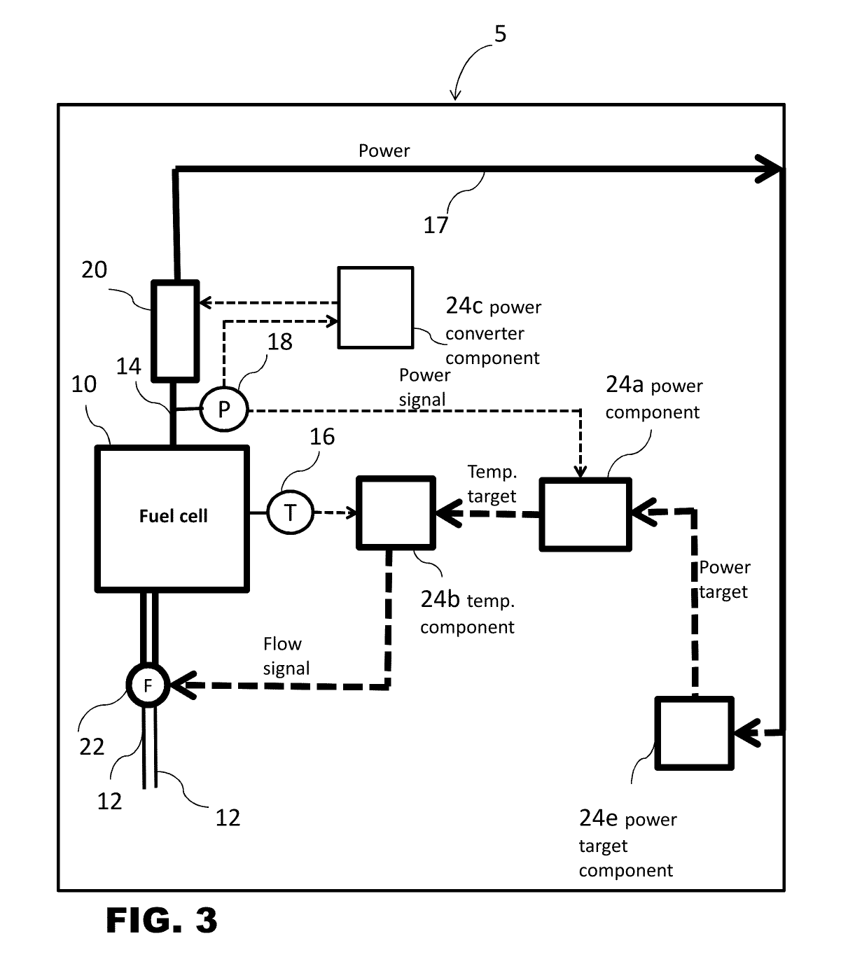

The fuel cell system controller 24 can include one or more components for implementing control loops (such as exemplary components 24a-24e shown in FIGS. 2A-3). The fuel cell system controller 24 is configured to operate a power control loop, a fuel cell temperature control loop, and a power converter control loop. Referring to FIG. 2A, the power control loop (outlined in bold lines for clarity and ease of representation), having the measured power parameter as an input, is operated by power component 24a configured to set a temperature target value of the fuel cell temperature to cause the power parameter measured by power sensor 18 to match the power target value.

Referring to FIG. 2B, the fuel cell temperature control loop (outlined in bold), having the measured operating temperature of the fuel cell 10 as an input, is operated by temperature component 24b configured to adjust flow using the flow control device 22 to cause the measured operating temperature of the fuel cell 10 to match the temperature target value.

According to one embodiment of the present invention, as illustrated in FIG. 2C, fuel cell 10 can also include electrical fuel cell heater 27 and electrical heater controller 28. The temperature component 24b, having the measured operating temperature of the fuel cell 10 as an input, can be configured to adjust flow using the flow control device 22, and to adjust power using the electrical heater controller 28 to cause the measured operating temperature of the fuel cell 10 to match the temperature target value. The temperature component 24b can be configured to operate the electrical heater controller 28 as part of the fuel temperature control loop or independent from the fuel temperature control loop.

Referring to FIG. 2D, the power converter control loop (outlined in bold), having the measured power parameter as an input, is operated by power converter component 24c configured to adjust the controllable power converter 20 to maximize the measured power parameter. The power target control loop is coupled to the temperature target control loop, while the power converter control loop independently seeks to increase the fuel cell power parameter. The fuel cell power parameter can change with respect to operating voltage at different operating conditions such as fuel cell temperature as outlined above.

According to another embodiment of the present invention, the fuel cell system controller 24 can be also configured to operate a power target control loop. Referring to FIG. 3, the power target control loop (outlined in bold), having one or more parameters associated with operation of the fuel cell system 5 as an input, is operated by power target component 24e configured to set the power target value. The one or more parameters associated with operation of the fuel cell system 5 can include power being used to charge a battery (not shown), to supply power to an external load (not shown), to supply power required to run the fuel cell system 5, and power produced by the fuel cell 10. The power target value can be the difference between the power produced by the fuel cell 10 and the power required to run the fuel cell system 5. In some embodiments, the power target value can be the sum of power being used to charge the battery, to supply power to the external load, and to supply power required to run the fuel system 5. In other embodiments, the power target value can be a fixed number based on a performance level of the fuel cell system 5. The power target control loop can be configured with a window for the system power target value. For example, the power target value can range from 0 W to 50 W. In another example, for a system targeted at charging mobile device, the power target can range from 0 W to 10 W.

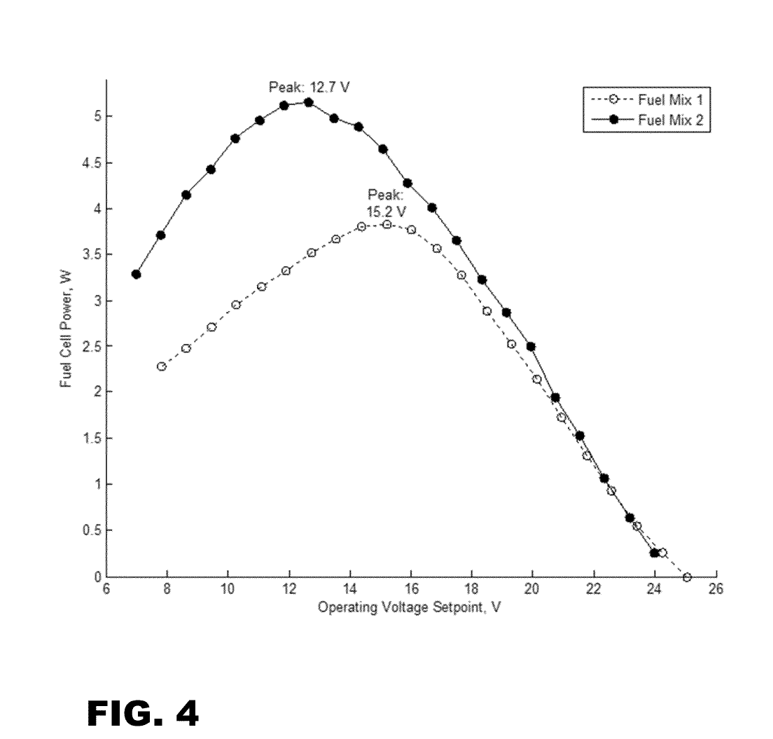

FIG. 4 illustrates the change in the fuel cell power in watts with respect to the operating voltage in volts at two different operating conditions, labeled “fuel mix 1” and “fuel mix 2.” As can be seen from the graph, at one operating condition of the fuel cell system (fuel mix 1), the maximum power is reached at the operating voltage set point equal to 15.2V, whereas, at another operating condition of the fuel cell system (fuel mix 2), the peak power is reached at the operating voltage set point equal to 12.7V. Thus, the peak fuel cell power varies with the change in the operating conditions of the fuel cell system 5. In one embodiment, the power converter control loop is configured to increase the power parameter by constantly seeking the operating voltage set point at which the power is at its maximum value, independently from other control loops. Alternatively, the operating current set point may be varied. Such finding and tracking the maximum power point can be accomplished using various approaches, one of which can be seeking the maximum power point by changing the voltage (or current) and detecting the change in the power output, wherein the direction of the change is reversed when the power decreases. Another suitable approach is changing the operating voltage within pre-set voltage ranges dependent on the current operating state of the fuel cell system 5. For example, if the fuel cell system 5 is in the start-up mode, the power converter control loop can be configured to seek the maximum voltage in a certain range corresponding to this particular mode, e.g., start changing the operating voltage from 14 Volts to 20 Volts (for the “fuel mix 1” condition shown in FIG. 4); and when the fuel cell system is in the operation state, start changing the operating voltage from 10 Volts to 16 Volts (for the “fuel mix 2” condition shown in FIG. 4).

The flow control device 22 can be a stand-alone device, such as shown in FIG. 1, or the flow control device 22 can be a group of discrete components operated by the fuel cell system controller 24. For example, the flow control device 22 can be a combination of one or more regulating valves and one or more sensors operated by the fuel cell system controller 24; or the flow control device 22 can be a combination of one or more pumps and one or more sensors operated by the fuel cell system controller 24. The power output sensor 18 can be coupled to the fuel cell power output 14, as shown in FIG. 1, or the power output sensor 18 can be coupled to the power line 17 downstream of the controllable power converter 20. Alternatively, the power output sensor 18 can be coupled to the controllable power converter 20.

In related embodiments, the power converter control loop may be operational whenever the fuel cell 10 (shown in FIGS. 1-3) is producing power. The fuel cell temperature target control loop may be configured with a window for the temperature target value. For example, the temperature target value can be in the range from 500 degree C. to 900 degree C. The flow control loop may be configured with a window for the flow control value. For example, the fuel flow can be in the range from 1 sccm to 25 sccm. The controllable power converter 20 may be configured to operate within a window of values. For example, the power can range from 1 W to 50 W depending on system application and load requirements.

The fuel cell system controller 24 (shown in FIG. 1) can have at least three operating states that may include startup operation of the fuel cell 10 preparing the system 5 to produce power, operation of the fuel cell 10 in which the fuel cell 10 produces power, and shutdown of the fuel cell 10 in which the system 5 stops the production of power. The initial target value for any of the control loops in the system 5 can change depending on the operating state of the fuel cell system controller 24. The window for any of the control loops in the system 5 can change depending on the operating state of the fuel cell system controller 24. In some embodiments, the fuel cell system controller 24 can store a past target value or values of any of the control loops. The target value for any of the fuel cell system control loops can be set by the fuel cell system controller 24 based upon one or more past target values.

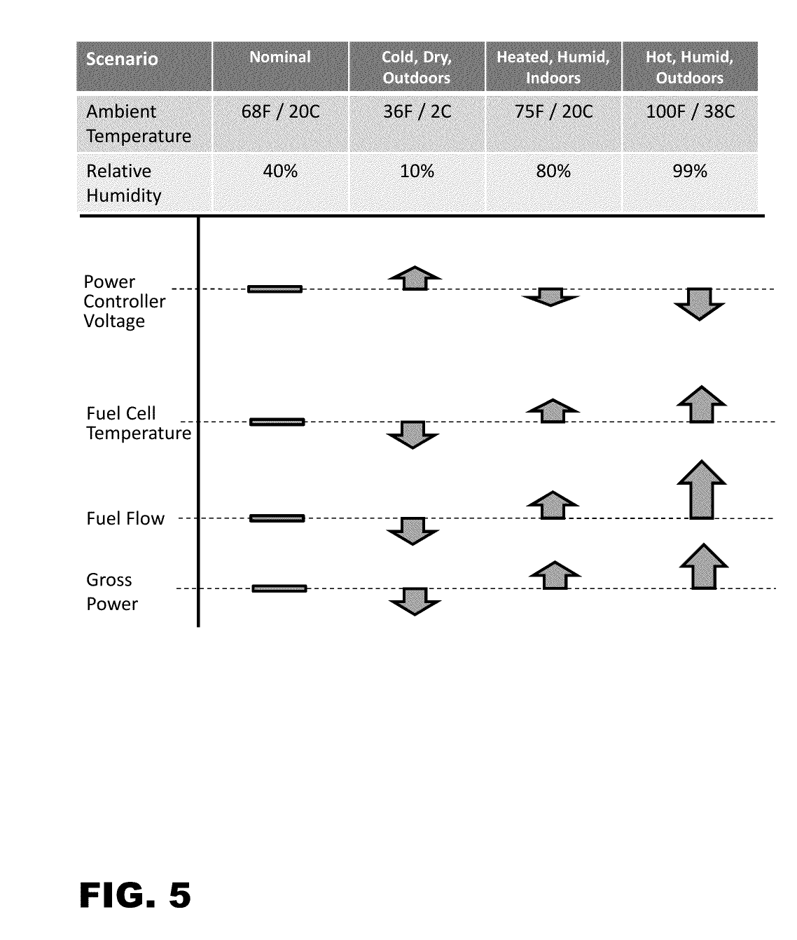

FIG. 5 is a table illustrating a potential system response to the initial change in the operating environment, which affects the balance of plant power, when moving a system 5 from a first “nominal” operating environment to one of three other operating environments. Two of the most important, of many possible factors, that affect the operation of a mobile fuel cell system are ambient temperature and relative humidity. Ambient temperature affects how much heat can be dissipated from the fuel cell system to the environment and relative humidity affects the concentration of oxygen and water in the air used in fuel cell operation. The change in the operating environment (e.g., change in ambient temperature, relative humidity, etc.) will cause the system 5 to adjust the fuel cell 10 state parameters, such as the gross power produced by the fuel cell 10, the fuel cell 10 operating temperature, the power controller voltage, and the fuel flow. For example, in one instance, when the system 5 is moved from a first “nominal” operating environment to “hot, humid, outdoors” operating environment, the system 5 may respond to such a change by increasing the gross power, the fuel flow and the fuel cell temperature, and by decreasing the power controller voltage, as illustrated in FIG. 5. In another embodiment, moving the system from the “nominal” operating environment to “cold, dry, outdoors” operating environment may prompt the system to respond to the change by decreasing the fuel cell 10 temperature, fuel flow, and gross power, and by increasing the power controller voltage, as illustrated in FIG. 5.

In some embodiments, the fuel cell 10 may be a solid oxide fuel cell. The fuel used by the fuel cell system 5 can be a liquid hydrocarbon. For example, the fuel used by the fuel cell system 5 can be butane.

The embodiments of the invention described above are intended to be merely exemplary; numerous variations and modifications will be apparent to those skilled in the art. All such variations and modifications are intended to be within the scope of the present invention as defined in any appended claims. For example, although some features may be included in some embodiments and drawings and not in others, these features may be combined with any of the other features in accordance with embodiments of the invention as would be readily apparent to those skilled in the art based on the teachings herein.

What is claimed is:

1. A portable fuel cell system, comprising;
a fuel cell having a plurality of flow inputs and a power output;
a temperature sensor configured to measure operating temperature of the fuel cell;
a power output sensor coupled to the fuel cell and configured to measure a power parameter related to fuel cell power output;
a controllable power converter, coupled to the power output of the fuel cell, that transfers power from the fuel cell to the fuel cell system;
a flow control device coupled to a first flow input and configured to control a first one of the flow inputs into the fuel cell; and
a fuel cell system controller, coupled to the fuel cell, the power output, the temperature sensor, the power output sensor, the controllable power converter, and the flow control device, the fuel cell system controller configured to operate:
a power control loop, having the measured power parameter as an input, configured to set a temperature target value of the fuel cell temperature to cause the measured power parameter to match a power target value;
a fuel cell temperature control loop, having the measured operating temperature of the fuel cell as an input, configured to adjust the first flow using the first flow control device to cause the measured operating temperature of the fuel cell to match the temperature target value; and
a power converter control loop, having the measured power parameter as an input, configured to adjust the controllable power converter to maximize the measured power parameter.

2. A portable fuel cell system according to claim 1, wherein the fuel cell system controller is further configured to operate a power target control loop, having at least one parameter associated with operation of the fuel cell system as an input, configured to set the power target value.

3. A portable fuel cell system according to claim 2, wherein the at least one parameter includes at least one member selected from the group consisting of amount of power being used to charge a battery that is coupled to the power output, amount of power from the system being delivered to an external load, amount of power required to run the system, amount of the fuel cell power output, and combinations thereof.

4. A portable fuel cell system according to claim 3, wherein the power target value is a difference between the amount of the fuel cell power output and the amount of the power required to run the system.

5. A portable fuel cell system according to claim 3, wherein the power target value is the sum of the amount of power being used to charge the battery, the amount of power being delivered to the external load, and the amount of power required to run the system.

6. A portable fuel system according to claim 2, wherein the power target value is a fixed number based on a performance level of the fuel cell system.

7. A portable fuel cell system according to claim 1, wherein the fuel cell system controller is further configured to operate the power converter control loop whenever the fuel cell is producing power.

8. A portable fuel cell system according to claim 2, wherein the fuel cell power target control loop is further configured to set the power target value to be within a power target window.

9. A portable fuel cell system according to claim 1, wherein the fuel cell power control loop is further configured to set the temperature target value to be within a temperature target window.

10. A portable fuel cell system according to claim 1, wherein the fuel cell temperature control loop is further configured to set the flow control value to be within a flow control window.

11. A portable fuel cell system according to claim 1, wherein the controllable power converter is configured to operate within a power window of values of the power output of the fuel cell.

12. A portable fuel cell system according to claim 1, wherein the fuel cell system controller is configured to run in each of at least three operating states, but in only one of the operating states at a given time, wherein the states include:
startup operation of the fuel cell to prepare the system to produce power;
operation of the fuel cell in which the fuel cell produces power; and
shutdown of the fuel cell to cause the system to stop the production of power.

13. A portable fuel cell system according to claim 12, wherein the fuel system controller is configured to change an initial target value for at least one of the control loops in the system depending on the current operating state of the fuel cell system controller.

14. A portable fuel cell system according to claim 12, wherein fuel system controller is configured to modify the window applicable to at least one of the control loops in the system depending on the current operating state of the fuel cell system controller.

15. A portable fuel cell system according to claim 1, where the fuel cell system controller is configured to store a past target value used in at least one of the control loops.

16. A portable fuel cell system according to claim 15, wherein the fuel cell system controller is configured to set the target value for at least one of the control loops based upon one or more past target values.

17. A portable fuel cell system according to claim 1, further comprising an electrical fuel cell heater and an electrical heater controller.

18. A portable fuel cell system according to claim 1, wherein the fuel cell is a solid oxide fuel cell.

19. A fuel cell system according to claim 1, wherein the fuel cell uses a liquid hydrocarbon fuel.

20. A fuel cell system according to claim 19, wherein the fuel is butane.
